(19) United States
(12) Patent Application Publication
(10) Pub. No.: US 2006/0112078 A1
(43) Pub. Date: May 25, 2006

(54) Information procurement

(75) Inventors: Sandeep Betarbet, Lilburn, GA (US); Sarita Dewitt, Stockbridge, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(73) Assignee: BellSouth Intellectual Property Corporation

(21) Appl. No.: 10/994,429

(22) Filed: Nov. 22, 2004

(51) Int. Cl. G06F 17/30

(52) U.S. Cl. 707/3

(57) ABSTRACT

Embodiments of the present disclosure provide systems and method for procuring published information in a network. Briefly described, in architecture, one embodiment of the system, among others, can be implemented as follows. The system includes an application manager that receives a message request from a user. The message request requests information about a service provided by a publication of an organization, such as a web page. The system further includes an application messaging device that responds to the message request with a message containing information on the service provided by the publication of the organization. Other systems and methods are also provided.

### TECHNICAL FIELD

The present disclosure is generally related to network communications and, more particularly, is related to information distribution.

### BACKGROUND

Companies or businesses often provide useful informational content to customers or users by directing them to visit a company web site. One purpose of a company web site is to provide useful information. Thus, web pages at a company web site are often loaded with a lot of informational content. While particular content might be helpful information to one user, the same content may not be helpful to another.

For example, a user may access a web site of a restaurant in order to look for today's menu specials offered by the restaurant. In addition to menu information, informational content provided by the web site may also include the history of the restaurant, its affiliations, directions, hours of operation, methods of payments, and newspaper reviews. Thus, it may be difficult for a user to receive information about the menu specials in a minimum amount of time without having to navigate through extraneous content in order to locate the desired information.

Thus, a heretofore unaddressed need exists in the industry to address the aforementioned deficiencies and inadequacies.

### SUMMARY

Embodiments of the present disclosure provide systems and method for procuring published information in a network. Briefly described, in architecture, one embodiment of the system, among others, can be implemented as follows. The system includes an application manager that receives a message request from a user. The message request requests information about a service provided by a publication of an organization, such as a web page. The system further includes an application messaging device that responds to the message request with a message containing information on the service provided by the publication of the organization.

Embodiment of the present disclosure can also be viewed as providing methods for procuring published information in a network. In this regard, one embodiment of such a method, among others, can be broadly summarized by the following steps: receiving a request from a user to provide information on a service provided by an organization; retrieving a publication of the organization from the network, the publication containing information on the service requested by the user; and responding to the request from the user with information from the retrieved publication on the service requested by the user.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment, among others, of an information procurement system of the present disclosure.

FIG. 2 is diagram of a sample web page from a web server of the information procurement system of FIG. 1.

FIG. 3 is a diagram of sample HTML code for producing the web page of FIG. 2.

FIG. 4 is a diagram of a tree-like representation of the web page in FIG. 2.

FIG. 5 is a flowchart diagram showing the functionality of one embodiment, among others, of the information procurement system of FIG. 1.

FIG. 6 is a flowchart diagram showing the functionality of one embodiment, among others, of the information procurement system 100 for responding to a message request for a service.

FIG. 7 is a diagram of a sample table containing navigational directions for locating information in the web page of FIG. 2.

FIG. 8 is a flowchart diagram showing the functionality of one embodiment, among others, of the information procurement system 100 for responding to a message request for a service in the system of FIG. 1.

FIG. 9 is a diagram representing the interactions between a sender of a message request and the information procurement system of FIG. 1.

FIG. 10 is a diagram representing a communication message containing content of interest for a specified service in the system of FIG. 1.

FIG. 11 is a flowchart describing the functionality of one embodiment, among others, of the information procurement system that employs a voice messaging approach.

FIG. 12 is a block diagram of one embodiment, among others, of the information procurement system that employs a voice messaging approach.

### DETAILED DESCRIPTION

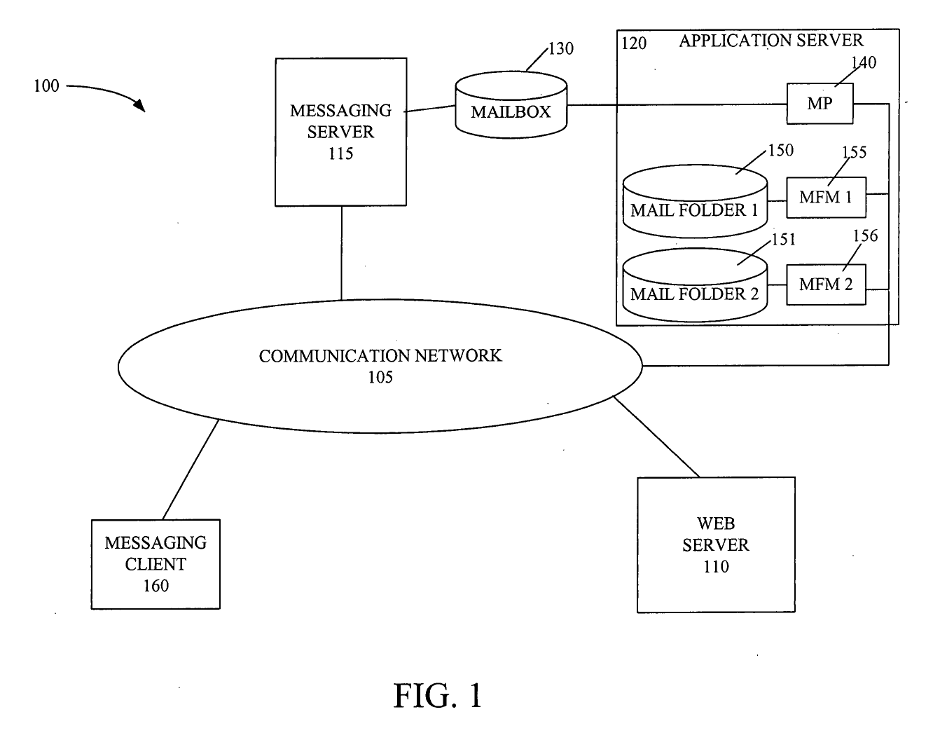

FIG. 1 is a block diagram of one embodiment 100 of an information procurement system of the present disclosure. As shown in FIG. 1, a communication network 105 (such as, but not limited to, the Internet) is included in the information procurement system 100 and communicates with a web server 110. The web server 110 serves web pages to requesting clients via a hypertext transfer protocol (HTTP). Also, an application server 120 is provided in the information procurement system 100. The application server 120 receives a request from a user for information about a particular subject. The application server 120 responds to the request with the requested information, if possible. In particular, the application server 120 receives a request from a user for certain information or service. In response, the application server 120 retrieves a specific web page from the web server 110; analyzes the contents of the retrieved web page; locates the requested information on the web page; and sends the requested information to the user as a communication message. One approach, for example, utilizes e-mail communications, among others, for distributing this information to the user.

The application server 120 includes multiple components to facilitate the receiving and answering of user queries. A mail processor (“MP”) 140 monitors communication messages (e.g., e-mail messages, telephone communications, etc.) received in the mailbox 130 and periodically polls the mailbox 130 to check for new messages. To access the mailbox for the application server 120, the mail processor 140 is made aware of (a) the network protocol used for retrieving mail (e.g., “imap”, “pop3”, “webdav”, etc.); (b) the computer host or messaging server 115 which returns mail messages by accessing the mailbox 130; (c) the port at the host 115 at which mail messages should be requested; (d) the mail folder 150 in which the mail messages should be stored; and (e) a user name and password for receiving permission to access the mailbox 130.

If there are communication messages received, the mail processor 140 passes the communication messages to an appropriate mail folder 150, 151 for processing by the application server 130. For example, different organizations or entities may maintain individual web sites for publicizing information about a particular business or subject. Therefore, each organization is associated with a mail folder 150. Further, a mail folder manager (“MFM”) 155, 156 is also associated with a particular mail folder 150, 151. Each mail folder manager 155, 156 analyzes a new communication message passed to the mail folder to determine if the message is directed at a service that is handled by the particular mail folder manager for an organization or if additional information is needed to process the request contained in the message. While each mail folder manager 155, 156 may share common or default procedures for processing a message request, a particular mail folder manager may include processes that are specific to a particular mail folder 150, 151 and overrides a default procedure. An example procedure is the retrieval of requested information located on a web page of an organization.

In accordance with one embodiment of the present disclosure, a user can send a request (via a communication message) to the application server 130 by identifying an organizational or business category; a name of a particular organization or business within the category; and a service provided by the particular organization or business. Note: the organizational category is the grouping to which an organization or business belongs, such as Plumbers or Florists. An organizational name is the name of the organization in the organizational category about which the user is interested in receiving information (e.g., Tom's Flower Shop). A service pertains to a request for information to be retrieved by the information procurement system 100 from a document maintained by the organization (e.g., hours of operation for Tom's Flower Shop). For example, for a restaurant business, a user may like to receive menu information about the restaurant. Therefore, one example service is a request for menu information from a website of the business. Additional services, in this example, could also include directions to the restaurant, hours of operation, etc.

Based on the organizational category, name, and service, the mail folder manager 155 determines the network address of a web page (or some other published document) of the organization that contains the requested information regarding the service of interest. To do so, the mail folder manager 155 and/or mail processor 140 maintain lists of information for determining if the mail folder manager 155 is able to provide the requested information. For example, the mail processor 140 maintains a list of business categories that are served by the information procurement system 100. Further, for each organizational category, the mail processor 140 maintains a list of organizations that are recognized under the particular organizational category. Then, each mail folder manager 155, 156 associated with an organization maintains a list of services provided by the organization.

Therefore, if the mail processor 140 finds a communication message requesting “Pricing Information” for a store “Tool Depot” in a business category of “Plumbers,” the mail processor 140 first checks to see if “Plumbers” is a registered or known category in the information procurement system 100, since the information procurement system may serve a limited number of categories. If an unknown or unregistered category is received, a message is returned to the user listing the known categories that are available by the mail processor 140 via the messaging server 115. Next, the mail processor 140 determines if “Tool Depot” is a registered or known organization under the specified organizational category (“Plumbers”), since a limited number of organizations may be provided. If it is, then the mail message is forwarded to the mail folder associated with the particular organization or business (“Tool Depot”). On the other hand, if the specified organizational name is not known, then a communication message is returned to the user with the known business names listed under the specified organizational category by the mail processor 140 via the messaging server 115. The user can access the communication message via a messaging client 160 (such as an e-mail client, a telephone device, etc.).

After the mail folder 150 receives the new message from mail processor 140, the mail folder manager 155 checks to determine if the requested service is a known service provided by the organization (“Tool Depot”), since the organization may provide a limited number of services. If it is, then the mail folder manager 155 looks up the address of a web page (or some other published document) that is known to contain the contents of information related to the requested service. For a web site, for example, each web page of the web site could provide a different service. Therefore, the mail folder manager 155 may maintain a list of network addresses of the web page that is associated with a particular service. Therefore, for a particular service, the mail folder manager 155 can retrieve the appropriate web page that contains information for providing the requested service. In addition, the mail folder manager 155 looks up navigational directions for locating the requested information within the retrieved web page. Using the navigational directions, the mail folder manager 155 retrieves the requested information and sends the requested information to the user in a communication message, such as an e-mail message, for example.

If the requested service is an unknown service that is not provided by the organization, the mail folder manager 155 instructs a messaging server 115 to send a communication message back to the user with a list of the known services provided by the organization, so that the user can respond by selecting a known service from the list (via a messaging client 160).

Consider that many organizations and businesses maintain a web site with an abundant amount of information. As such, the web site is composed of a multitude of individual web pages, where individual web pages are often organized by a common topic or group of topics. Therefore, for a particular organization that maintains a web site, an administrator of the information procurement system 100 can construct a list of services associated with the organization, such as hours of operation; pricing information; directions; contact information; certain product information; etc. Further, each identified service can be associated with a particular web page that contains helpful information about the service. In particular, for each service, the organization can identify the address of the particular web page that contains information about the service and maintain this information in a list. Further, the administrator can identify the specific location of the information within the particular page and also maintain this location information in a list. With these two pieces of information (e.g., the web page address and navigational directions for finding the requested information within the web page), the mail folder manager 155 can automatically locate requested information regarding a registered service and send the requested information back to the user in a variety of communication mediums.

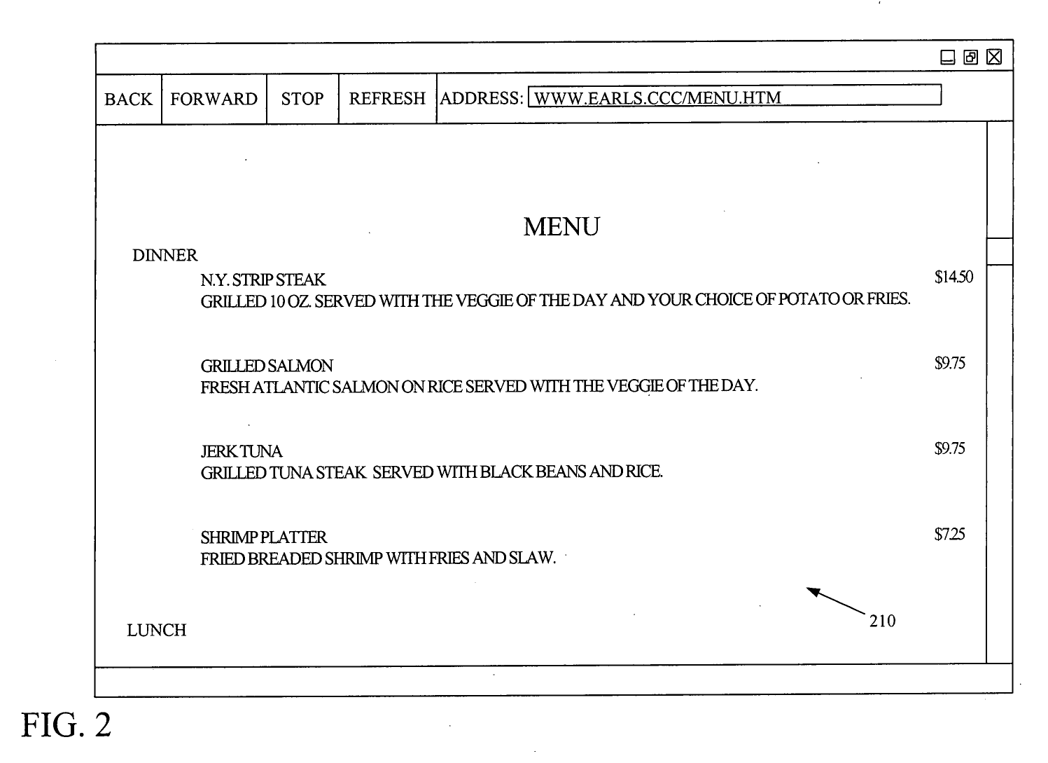

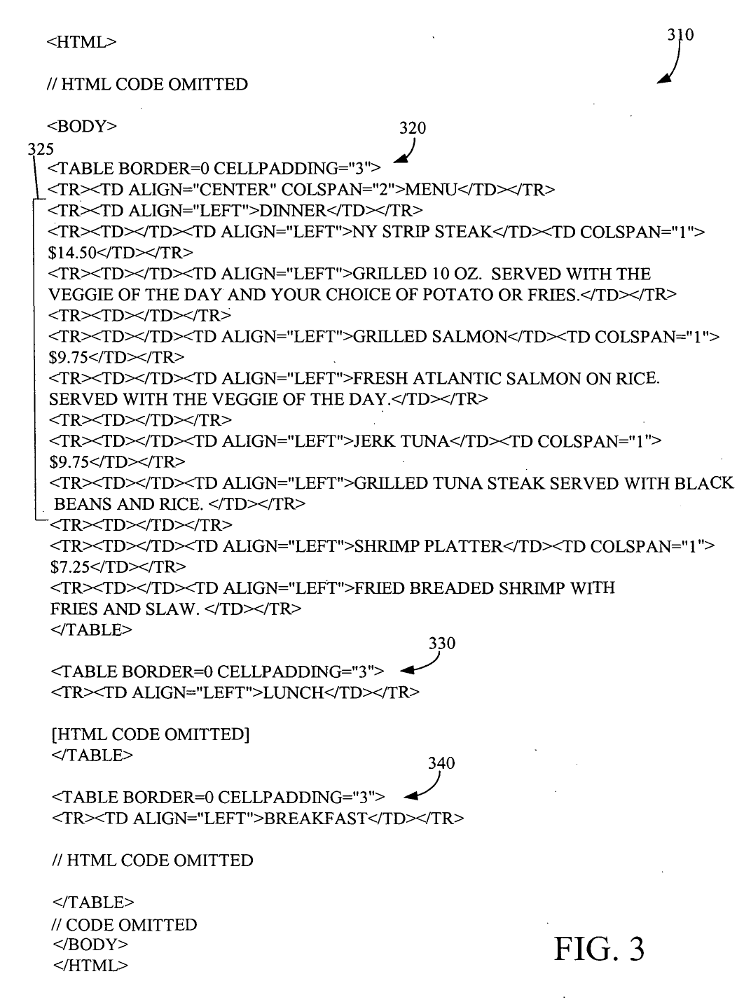

For example, FIG. 2 displays a sample web page from a web site of a business being displayed in a generic web browser. In the example of FIG. 2, a web page at network address http://www.earls.ccc/menu.htm shows menu information for a restaurant named Earl's Diner, as indicated by pointer 210. Next, FIG. 3 shows sample HTML (“HyperText Markup Language”) code 310 for producing the web page of FIG. 2. The sample HTML code contains several table elements 320, 330, 340. As indicated by bracket 325, certain columns and rows of table 320 contain dinner menu information. Therefore, by knowing this directional information and the address of the web page, the requested information of interest can be determined.

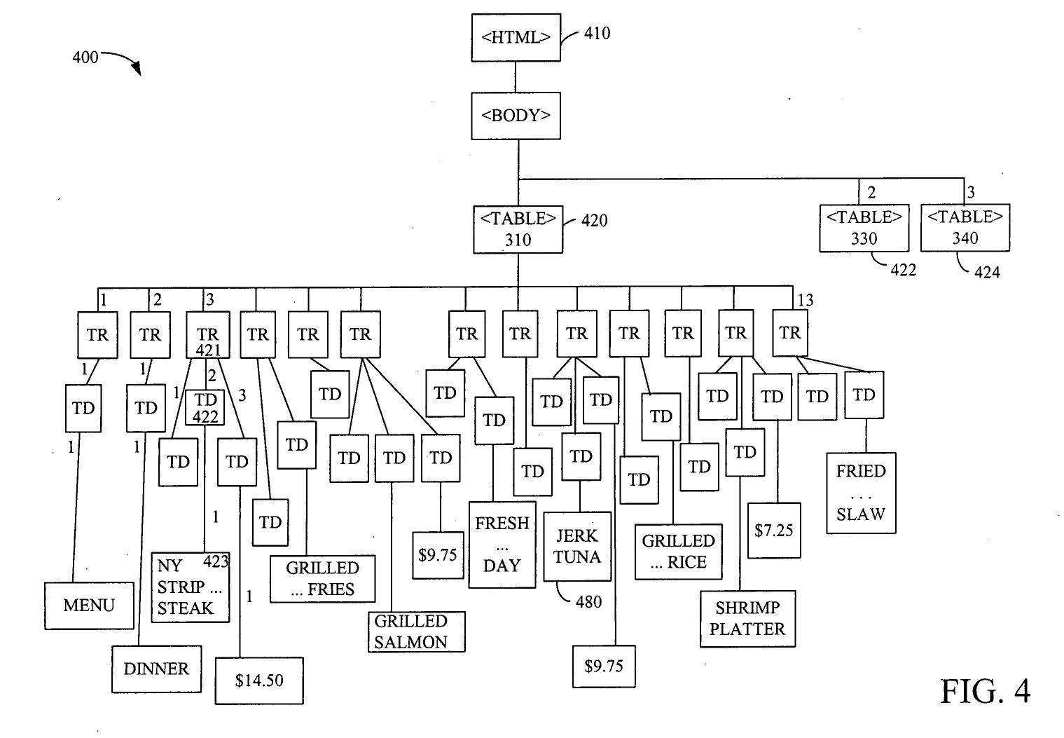

For further illustration, a tree-like representation of the structure of the web page in FIG. 2 is shown in FIG. 4. As previously shown, the HTML code 310 shows that the document is structured or organized using table elements. This document is now shown in FIG. 4 as a document model 400 using logical tree representations. The document model 400 defines the document (e.g., web page) as a number of nodes. At each node, an element node or text node is located. For the HTML document of FIG. 2, the <HTML> element node 410 is the top-level element node. Each node below the top-level node is a child of another node in the document model. In this way, the nodes are inter-related and one can traverse along a series of nodes to reach a node of interest.

As shown in FIG. 4, the document model 400 features several table element nodes 420, 422, 424. However, with a unique string or text node (“target string”), the mail folder manager 155 can locate the structural element of the web page that contains the target string. This is the structural element that contains information of interest. Then, with navigational directions for the retrieved document, the mail folder manager 155 can traverse the structure of the located structural element to find the content of interest (e.g., menu information) for the service provided by the organization.

For example, a unique text node within the example of FIG. 4 may be “Jerk Tuna” 480. Therefore, with the a particular target string, a mail folder manager 155 can traverse the document model tree and locate the text node 480 containing “Jerk Tuna” and therefore also identify the table node 420 that is a root of and contains the text node 480. Accordingly, the mail folder manager 155 can traverse the table tree beginning with the text node 480 (with the target string) to the root of the HTML table 420. Then from the table root node 420, navigational directions (that are associated with the service being performed) are followed to locate the text nodes which contain content of interest for the respective service.

Therefore, for a particular network address (e.g., uniform resource locator “URL”) of an organizational web site, the mail folder manager 155 maintains identification of a target string that is located at a text node, such as a specific and unique phrase, within a document that identifies a particular structural element in the document (e.g., a table element) that contains the requested information. Therefore, the mail folder manager 155 also maintains navigational directions for locating the content information within the formatting structure identified by the target string. Note, content information for a particular service can be regularly updated by an organization within a web page. The general structure or organization of information within a web page, however, should be static for a given set of navigational directions.

As discussed, in some embodiments, the mail folder manager 155 receives requests for information (via a message from a user) in a mailbox 130 representing a specific organization or business. The mail folder manager 155 interprets the message request as a request for specific content from a web page associated with the mailbox 130. The mail folder manager 155 makes a request to the web server 110 for documents, in a similar manner as a web browser. The mail folder manager 155 filters the response and returns a reply to the user (who made the original message request) via a communication message, such as e-mail. Accordingly, via some embodiments of the present disclosure, users can employ the information procurement system 100 in order to receive web site content as information through e-mail. Such uses are applicable to actionable information, such as, but not limited to: directions to the business, rates, times of operation, catalog information (e.g. restaurants menus), today's special, terms of exchange, etc. In addition, embodiments of the information procurement systems can be utilized as an alternative channel for delivering web site content at minimum cost, since users and administrators do not need to set up new client platforms, protocols or web servers.

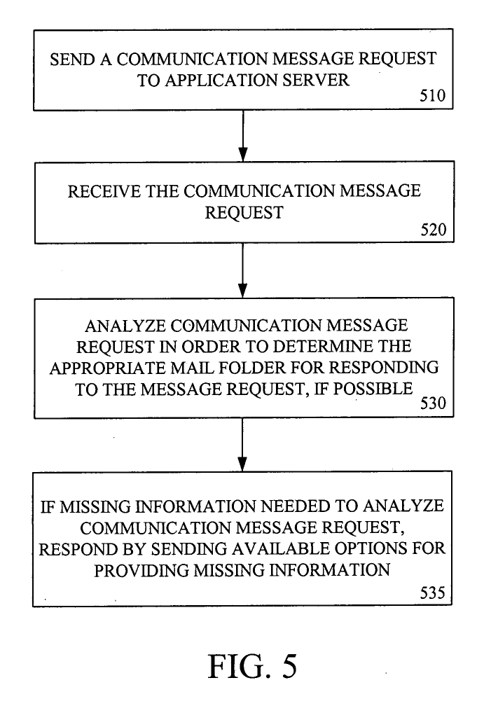

Next, the flowchart of FIG. 5 describes the functionality of one embodiment of the information procurement system of FIG. 1. First, a user sends (510) a communication message request to the application server. In some embodiments, the communication message request is sent in the form of an e-mail message. In other embodiments, the communication message request is sent in the form of a telephone voice transmission. Further, in other embodiments, the communication message request is generated using different communication mediums, such as an instant message or short message service (SMS), for example. For the discussion of FIG. 5, an e-mail communication is presumed. Next, the communication message request is received (520) by the application server. The communication message request is then analyzed (530) to determine the appropriate mail folder for responding to the communication message request, if possible. Accordingly, if the communication message request is missing information that should be provided to determine the appropriate mail folder, available options for providing the missing information are sent (535) to the user.

For example, for some embodiments, the communication message request is checked to see if it contains a business category. Typically, a user may specify the business category in the Subject field of an e-mail message request, for some embodiments. Then, the mail folder manager 155 parses the Subject of the e-mail message. If the message request does not identify a business category or specifies a business category not recognized by the information procurement system 100 (e.g., if the Subject of the e-mail message does not begin with a recognized category for which service is provided), a list of categories is returned to the sender of the communication message request.

Then, after the communication message has been checked for the category that is the subject of the request, the communication message request is checked to see if it contains a business name. Typically, a user may specify the business name in the Subject field of an e-mail message request after the business category. If the communication message request does not identify a recognized business name (e.g., if the Subject does not contain a recognized business name after a recognized category for which a service is provided), a list of business names belonging to the business category is returned to the sender of the mail message, in some embodiments.

Next, after the communication message has been checked for the category and business name that are the subject of the request, the communication message request is checked to see if it contains a recognized service offered by the identified business. Typically, a user may specify a service in the Subject of an e-mail message request after the business category and the business name. If the communication message request does not identify (e.g., if the Subject does not contain a recognized service after a recognized category and business name for which a service is provided) a recognized service, a list of services provided by the business is returned to the sender of the communication message. After the category, business name, and service has been identified, the information procurement system 100 is ready to process the service request.

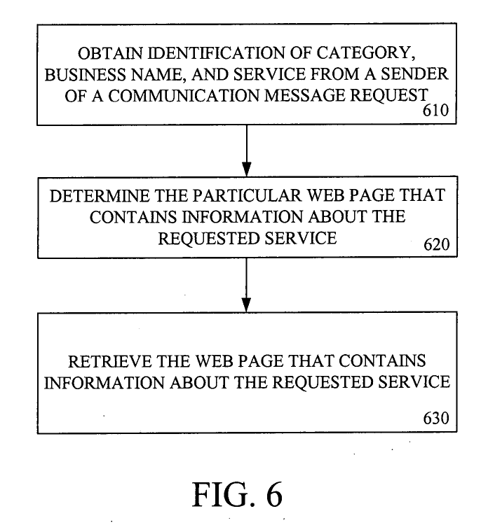

Accordingly, the flowchart of FIG. 6 shows the functionality of one embodiment, among others, of the information procurement system 100 for responding to a service request. As discussed with regard to FIG. 5, identification of category, business name, and service are obtained (610) from a sender of a communication message request. Then, a look-up operation is performed on a list of web page addresses that is associated with recognized services provided by the business to determine (620) the particular web page that contains information about the service. In particular, the particular service identified in the communication message request is associated with a particular web page (or set of web pages) from a web site of the business identified in the communication message request. This association is maintained on a list by the information procurement system 100. By utilizing the brief information provided by the sender, the web page that contains information about a requested service can be retrieved (630) by the information procurement system 100.

For example, in some embodiments, if the Subject of an e-mail message request does contain a recognized category and a recognized business (or organizational) name (for that category) and a recognized service (for that business name), the information procurement system 100 retrieves a List of Business Service URL's and locates the Business Service URL for the recognized service. Then, the web page/file to which the URL points is retrieved. The HTML code of the retrieved web page is parsed into a document model, such as a list of HTML tables. The mail folder manager 155 selects the single HTML Table in the List of HTML Tables which contains a target string associated with the recognized service and retrieved web page. The target string is maintained in a list of target strings for the different services. The content of interest is present in this HTML Table. Next, the text node that represents the target string is located. Next, the tree of HTML nodes is then traversed beginning with the text node containing the target string to the root of the HTML Table. From the HTML Table node, navigational directions 740 are used to locate text nodes which contain content of interest (e.g., menu information, etc.).

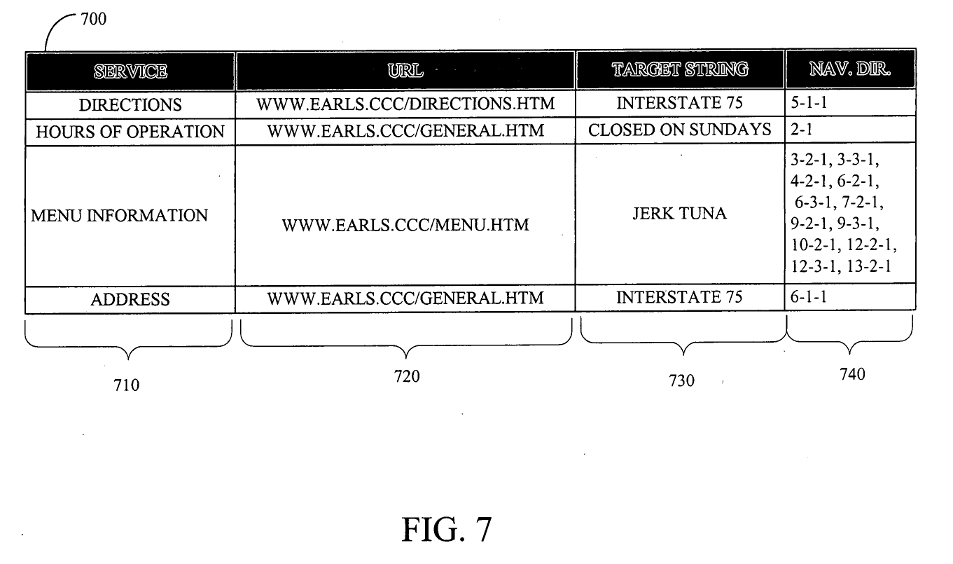

For example, FIG. 7 is a sample list or table 700 containing navigational directions for locating information associated with a service identified in a communication message request. As shown, the table 700 contains a column 710 of services provided by a particular business or organization. For each identified service, web page address(es) (“URLs”) 720 are provided, where the identified web pages contain information about the identified service. From the web page(s), a document model can be constructed to help locate content of interest. Further, for each identified service and web page address, a unique target string 730 and navigational directions 740 are contained, as indicated. For example, for the service “Menu Information,” the target string 730 is indicated as “Jerk Tuna.” Therefore, as previously discussed, using the target string 730, the only structural element containing the unique target string may be located. Once the structural element is located, the navigational directions can then be utilized to locate content of interest that has been requested by the user.

For example, referring to the document model of FIG. 4, table node 420 contains the unique target string “Jerk Tuna” as shown by text node 480. Therefore, using the navigational directions contained in table 700, the content of interest directed toward the service for providing menu information can be obtained. For this particular example, one set of the navigational directions indicate that content of interest can be located at a text node by following the direction (3-2-1) where the first number “3” represents that the table tree should be traversed by moving to the third (3-rd) element from the left listed under the table root node. In FIG. 4, this element is a table row (“TR”) element 421. The next number “2” in the directions, therefore, indicate that the tree should be further traversed by moving to the second (2-nd) element (from the left) listed under the previous node 421 which is a table row (“TR”) element 422. Accordingly, the tree is traversed according to the numbers specified in the navigational directions until the last number is reached in a set of navigational directions, such as the number “1”, in the current example. Accordingly, the tree is traversed from the previous element node 422 to the first (1-st) element node (from the left) which is the desired text node 423. The contents of the text node 423 is a portion of the content of interest that is to be provided to the user in response to the user's message request. The rest of the content of interest may be located using the other sets of navigational directions 740 provided in the table 700. After the content of interest has been determined, the mail folder manager 155 then composes a communication message having the requested information for sending to the user at the mail address the user provided in the original communication message request.

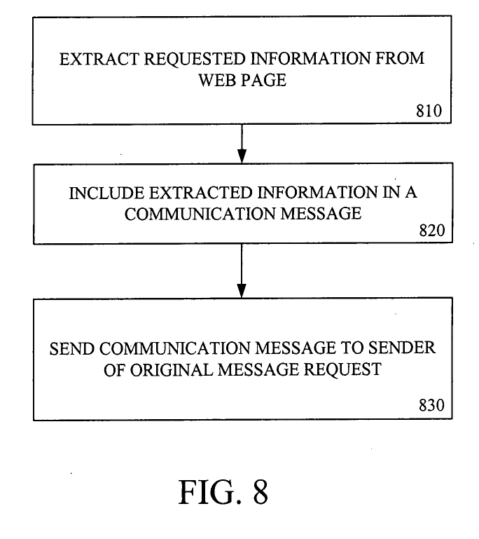

Next, the flowchart of FIG. 8 shows the functionality of one embodiment, among others, of the information procurement system 100 for responding to a communication message request for a service with requested information to the sender of the communication message request. After the requested information is located in a web page of an identified business or organization, as shown in FIG. 6, the requested information is extracted (810) from the web page and included (820) in a communication message. Note, the extracted information is reformatted and presented in the communication message in a structured and orderly manner. The communication message is then sent (830) to the sender of the original message request at the message address identified in the original message request. To send the communication message response, the mail folder manager 155, in some embodiments, utilizes a messaging server 155 that may be located remotely from the application server 120.

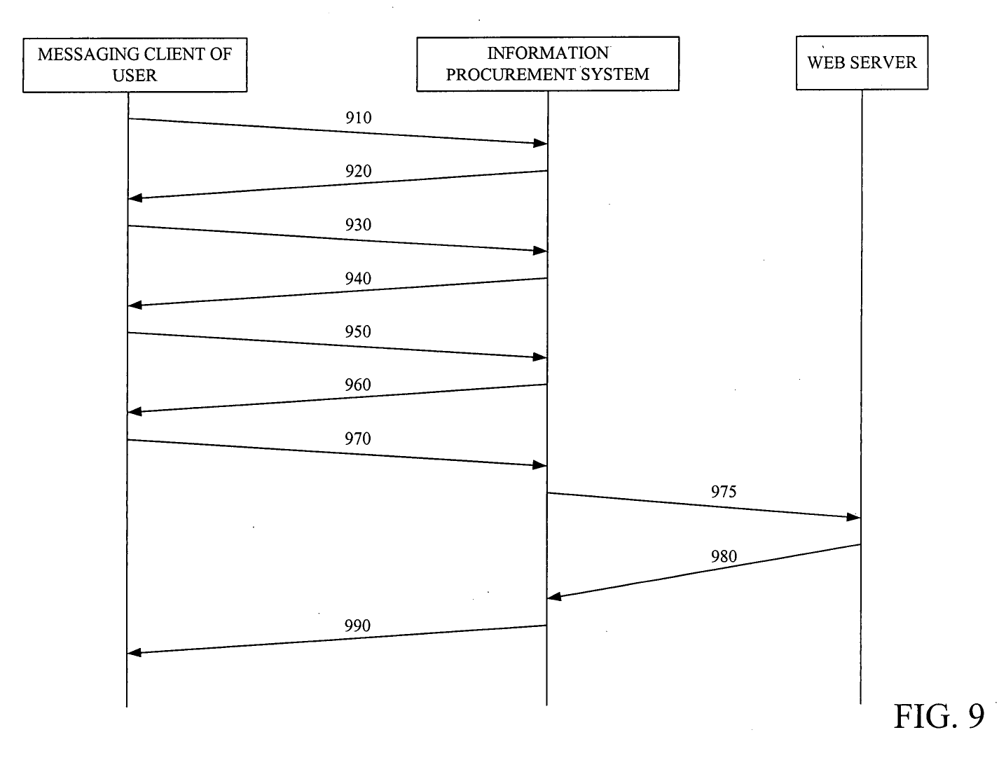

To further demonstrate the operations of the information procurement system 100 for one embodiment, FIG. 9 shows a diagram representing the interactions between a sender of a communication message request and the information procurement system 100, for one embodiment. First, a sender sends (910) an e-mail message request to a designated network address for the information procurement system 100. In this example, the sender does not specify a recognized category in the e-mail message request. Therefore, in response, the information procurement system 100 saves the e-mail address of the user and sends (920) the sender a list of categories recognized by the system (via an e-mail message) and instructs the sender to select a category from the list in a reply to the response. Accordingly, the sender replies (930) by selecting a category, but does not specify an organization for the selected category, in this example. For example, the sender may specify RESTAURANT as the category.

In response, the information procurement system 100 sends (940) the sender a list of organizations recognized by the system for the selected category (RESTAURANT) and instructs the sender to select an organization from the list in a reply to this response. Accordingly, the sender replies (950) by selecting an organization for the selected category. For example, the sender may specify EARL'S DINNER as the organization. In response, the information procurement system 100 sends (960) the sender a list of services recognized by the system as being offered by the selected organization and instructs the sender to select a service from the list in a reply to this response. Accordingly, the sender replies (970) by selecting a service for the selected business category. For example, the sender may specify MENU as the service. (Note, in accordance with the present embodiment, the sender could have specified in the original e-mail request each of the category, organizations, and service information.) Also, in some embodiments, the information procurement system 100 maintains a session for a user and stores information from previous communications, so that the user does not have to provide the organizational category (and other pertinent information) in each communication sent by the user.

With the category, organization, and service information, the information procurement system 100 looks up the network address of the organizational document(s) that contains the requested information. For example, to obtain menu information for Earl's Diner, the information procurement system 100 retrieves the set of information previously discussed in FIG. 7 for category: RESTAURANT; organization: EARL'S DINER; and service: MENU. Accordingly, a web page at URL http://www.earl.ccc/menu.htm is requested (975) and retrieved (980) from the web server 110 identified by the URL.

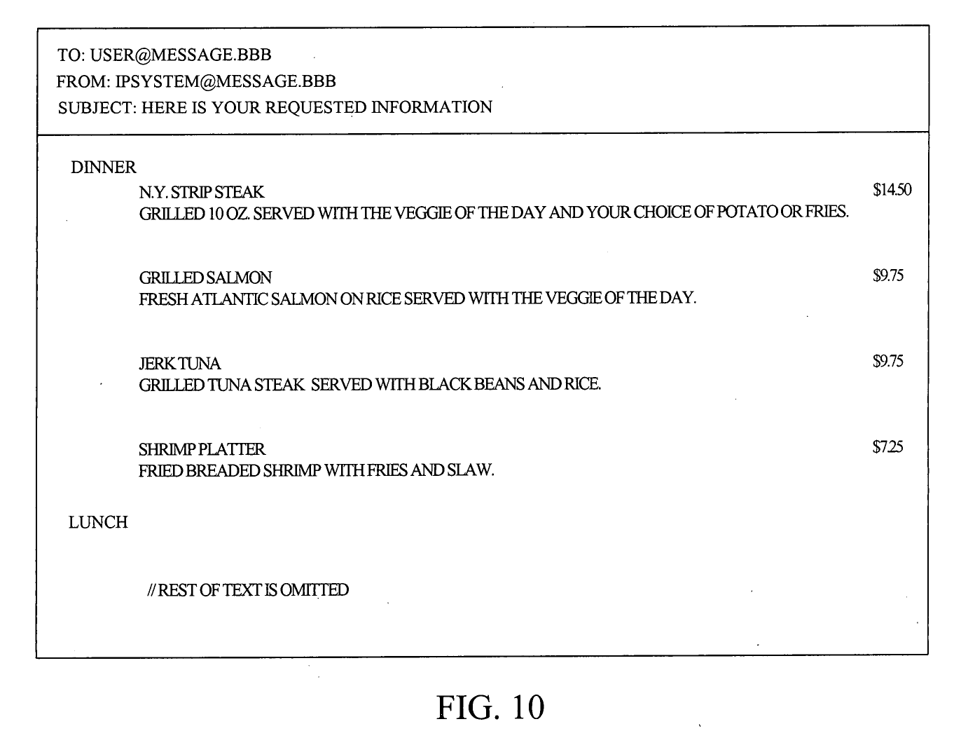

The retrieved web page is organized into a document model representing the web page. The target string 730 is used to identify a root node of a particular structural element. The navigational directions 740 are then used to traverse the structural element from the root node to locate and retrieve content of interest in the structural element (e.g., a HTML table, etc.). This information is then returned (990) to the sender in an e-mail message. The resulting content of interest that is returned in the example above is shown in FIG. 10 in a simplified version of a communication message that is provided to a user.

Note, in some embodiments, dynamic parameters may be passed included in a network address, such as a URL, that is invoked to retrieve a document from a web server 110. Accordingly, a mail folder manager 155 may be configured to accept parameters in communication messages and to add the parameters in a URL that is provided to a web server. For example, an address may be provided in a communication message and added to a URL query to a web site that provides map information and images. Therefore, for a service that provides customized mapping information, the communication message can contain necessary information that is used by the information procurement system 100 to return desired mapping information to a user. As another example, a user could provide a price ($10) as a parameter in a message request for a category FLORISTS; business JEN'S FLOWERS; and service PRICING. In response, the price parameter ($10) is added to the URL associated with the requested service in order to receive product information that have prices under $10.

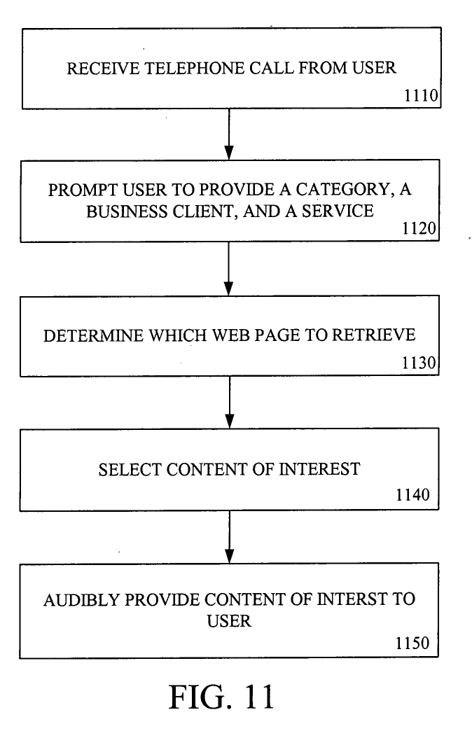

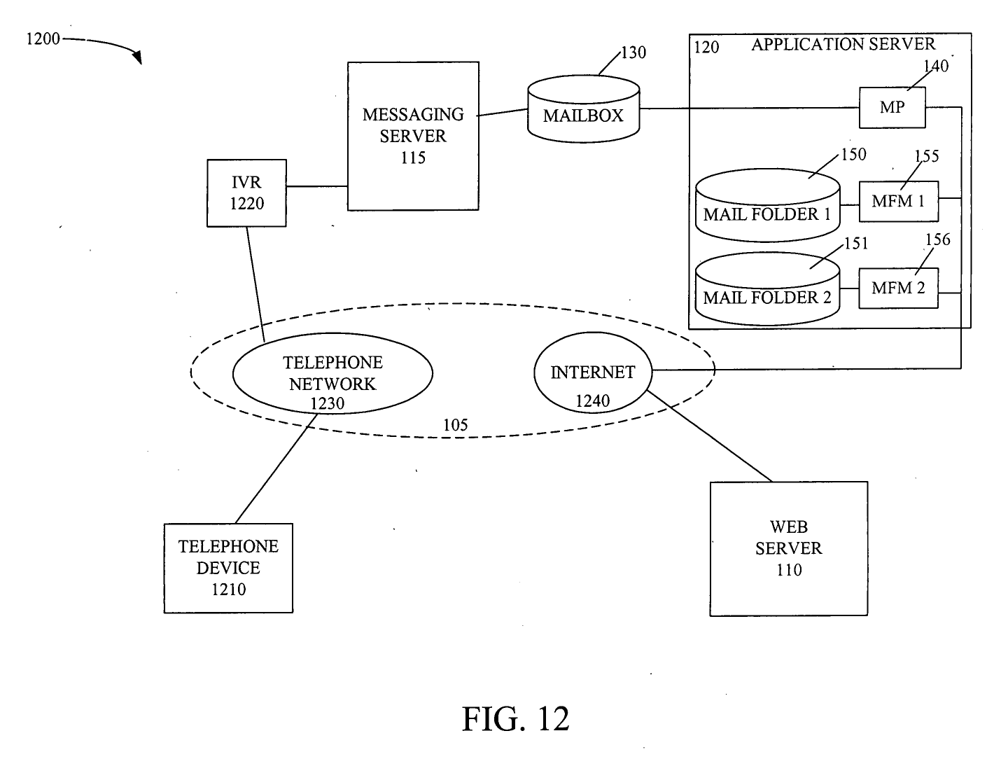

As previously stated, the information procurement system 100 may employ a wide variety of messaging formats and methods. Accordingly, FIG. 11 is a flowchart describing the functionality of one embodiment, among others, of the information procurement system that employs a voice messaging approach. Correspondingly, FIG. 12 is a system diagram 1200 of one embodiment of the information procurement system that employs a voice messaging approach.

For example, in this embodiment, a user (via a telephone device 1210) can place a telephone call (over a telephone network 1230) to a telephone number of an interactive voice response (IVR) unit 1220 of the information procurement system 100. Accordingly, the call is received (1110) by the information procurement system 1200. The IVR unit 1220 prompts (1120) the user to specify a category, an organization or business, and a service from the user. Note, in accordance with other embodiments of the present disclosure, the IVR unit 1210 can provide the user a list of options that the user may audibly choose or select by pressing a keypad on the user's telephone. From the user's selections or specifications, the information procurement system 1200 determines (1130) which web page to retrieve (via the Internet 1240). The information procurement system 1200 then parses the web page and selects (1140) content from that web page and audibly provides (1150) the information to the user via a telephone call using text to speech technology. The information procurement system may provide the retrieved information back to the user in the telephone call that was originally placed by the user or the system may call the user back to prompt the user to provide additional information or to provide retrieved information.

In accordance with the present disclosure, the embodiment of FIG. 12 may be employed in various mobile communication applications. One such use involves providing yellow pages information to a user over a mobile phone, such as locations of places for dining, lodging, entertaining, etc. Accordingly, a provider of the information procurement system can configure mail folder managers for accessing web sites of various customers, such as restaurants, florists, theaters, taxi companies, museums, etc, and providing desired information to web browsers, telephones, and general communication devices.

Components of embodiments of the present disclosure can be implemented in hardware, software, firmware, or a combination thereof. For example, in the some embodiments, the application server is implemented in software or firmware that is stored in a memory and that is executed by a suitable instruction execution system. If implemented in hardware, as in some alternative embodiments, the application server can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Further, components of embodiments of the present disclosure can also be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Any process descriptions or blocks in flow charts should be understood as representing modules, segments, or portions of code (which include one or more executable instructions for implementing specific logical functions) or steps in a process. As such, alternate implementations are also included within the scope of the embodiments of the present disclosure in which functions may be executed out of order from that shown or discussed, including substantially concurrently or in reverse order, depending on the functionality involved, as would be understood by a person having ordinary skill in the art of the present disclosure.

It should be emphasized that the above-described embodiments of the present disclosure are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and protected by the following claims.

Therefore, having thus described the invention, at least the following is claimed:

1. A system for procuring published information in a network, comprising:
an application manager receiving a message request from a user, the message request requesting information about a service provided by a publication of an organization; and
an application messaging device responding to the message request with a message containing information on the service provided by the publication of the organization.

2. The system of claim 1, wherein the publication is a web site for the organization.

3. The system of claim 1, the application manager further configured to retrieve a publication that provides information on the service.

4. The system of claim 3, wherein the application manager analyzes the retrieved publication to locate and extract the information on the service and provides the extracted information to the application messaging device.

5. The system of claim 4, wherein the application manager locates the information on the service by consulting stored information that provides instructions for locating information associated with a particular service.

6. The system of claim 1, wherein the application manager prompts the user to provide additional information if the application manager is unable to ascertain about which service the user is interested.

7. A method for procuring published information in a network, comprising the steps of:
receiving a request from a user to provide information on a service provided by an organization;
retrieving a publication of the organization from the network, the publication containing information on the service requested by the user; and
responding to the request from the user with information from the retrieved publication on the service requested by the user.

8. The method of claim 7, wherein the request from the user is in the form of an e-mail message.

9. The method of claim 7, wherein the request from the user in the form of a telephone call placed by the user.

10. The method of claim 7, wherein the response to the request from the user is in the form of an e-mail message.

11. The method of claim 7, wherein the response to the request from the user is in the form of a telephone call to the user.

12. The method of claim 7, further comprising the steps of:
analyzing the retrieved publication to locate information on the service requested by the user.

13. The method of claim 12, further comprising the steps of:
extracting the located information on the service requested by the user; and
including the extracted information in a message that is sent to the user in response to the request from the user.

14. The method of claim 7, further comprising the step of:
prompting the user to provide additional information to determine the particular service about which the user is inquiring.

15. The method of claim 14, wherein the additional information includes a general category about which the service pertains.

16. The method of claim 15, wherein the additional information includes a particular organization that performs the service.

17. The method of claim 7, wherein the request from the user identifies a general category about which the service pertains and a particular organization that performs the service.

18. A computer readable medium having a program for procuring published information in a network, the program performing the steps of:
receiving a request from a user to provide information on a service provided by an organization;
retrieving a publication of the organization from the network, the publication containing information on the service requested by the user; and
responding to the request from the user with information from the retrieved publication on the service requested by the user.

19. The medium of claim 18, the program further performing the steps of:
analyzing the retrieved publication to locate information on the service requested by the user;
extracting the located information on the service requested by the user; and
including the extracted information in a message that is sent to the user in response to the request from the user.

20. The medium of claim 19, the program further performing the step of:
prompting the user to provide additional information to determine the particular service about which the user is inquiring.
